(19) United States
(12) Patent Application Publication
(10) Pub. No.: US 2026/0111731 A1
(43) Pub. Date: Apr. 23, 2026

(54) Learning Model Task Performance Using a Graph

(71) Applicant: eBay Inc., San Jose, CA (US)

(72) Inventors: Kan Lin, Shanghai (CN); Wei Liu, Shanghai (CN); Zhenhua Ma, Shanghai (CN); Yongkang Shen, Shanghai (CN); Junjuan Shi, Shanghai (CN)

(73) Assignee: eBay Inc., San Jose, CA (US)

(21) Appl. No.: 18/921,584

(22) Filed: Oct. 21, 2024

(51) Int. Cl. G06N 3/082; G06N 3/042; G06N 3/091

(52) U.S. Cl. CPC G06N 3/082; G06N 3/042; G06N 3/091

(57) ABSTRACT

Learning model task performance using a graph is described. A computing system can receive a prompt for performing a task using a learning model, where the task includes intermediate tasks. The computing system generates a graph to represent relationships between at least one term included in the prompt and additional terms associated with performing the task. The graph includes nodes corresponding to the at least one term and the additional terms and edges connecting the nodes. The edges correspond to the relationships between the at least one term and the additional terms. The computing system performs the intermediate tasks based on the graph to obtain a response to the prompt, where the intermediate tasks are associated with the additional terms. In some cases, the computing system removes one or more nodes from the graph responsive to results of the intermediate tasks. The computing system broadcasts the response to the prompt.

### BACKGROUND

A computer system may implement machine learning techniques, or artificial intelligence, to generate an output given a prompt as input. For example, a computer system may utilize a learning model to generate content, data, or outputs that were not explicitly programmed or provided to the learning model in training data. The learning model is trained utilizing deep learning techniques (e.g., neural networks) to detect patterns and structures within the training data. In some examples, the learning model may include one or more large language models (LLMs) for generating text in response to prompts or queries. An LLM may capture patterns and relationships in language, enabling the model to understand context, generate coherent text, and perform various natural language processing tasks.

### SUMMARY

A computing system may implement one or more learning models (e.g., LLMs) to complete a task. For example, the computing system receives a prompt that indicates the task and implements the learning models to perform the task by generating a response to the prompt. The task can be divided into multiple intermediate tasks. For example, if the task is to define a variable, then the intermediate tasks can include defining sub-variables of the variable. The computing system can generate a graph to represent relationships between terms in a prompt and additional terms for performing the task. The computing system performs intermediate tasks by traversing the graph to obtain a response to the prompt. In some cases, the computing system dynamically updates the graph by removing nodes, such as when a size of the graph exceeds a threshold value. Once the computing system obtains the response, the computing system broadcasts the response. Implementing a graph to obtain a response to a prompt enhances processing capabilities of learning models by reducing incorrect solutions, premature termination, and/or processing related to learning models becoming stuck in processing loops.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures.

FIG. 1 is an illustration of an environment in an example implementation that is operable to employ techniques described herein.

FIG. 2 depicts an example diagram of processing of a prompt to obtain an output using a graph.

FIG. 3 depicts an example graph depicting relationships between variables for learning model task performance.

FIG. 4 depicts an example of a user interface for learning model task performance using a graph.

FIGS. 5 and 6 depict procedures in example implementations of learning model task performance using a graph.

FIG. 7 illustrates an example of a system that includes an example computing device that is representative of one or more computing systems and/or devices that may implement the various techniques described herein.

### DETAILED DESCRIPTION

### Overview

Learning model task performance using a graph is described. In accordance with the described techniques, a learning model system receives a prompt for performing a task using a learning model. The task may include multiple intermediate tasks. The learning model system generates a graph to represent relationships between one or more terms in the prompt and additional terms used to perform the task. The graph may include nodes for respective terms and edges connecting the nodes. The edges define the relationships between the terms. The computing device performs the intermediate tasks to obtain a response to the prompt (e.g., complete, perform, execute the task). In some examples, the learning model system removes nodes from the graph responsive to results of the intermediate tasks. The learning model system broadcasts the response to the prompt (e.g., to one or more computing devices or via a user interface of a computing device).

One or more learning models can implement a framework for completing a task, where a task can have multiple steps (e.g., intermediate tasks). The learning models may use an output from a step in the task to analyze, process, and/or execute a subsequent step in the task, such that the steps can have dependencies. An example framework can include a reasoning and acting (ReAct) framework, in which the learning models iteratively analyze a step in a task, execute an action, and acquire data from the action results. The learning models can repeat the analysis, execution, and data acquisition for respective steps in the task until the learning models produce an output (e.g., a solution to the task) that satisfies one or more performance metrics or until a termination condition is reached. However, as the dependencies between steps in a task become increasingly complex, the ReAct framework may not maintain coherence and efficiency in completing the task, which can reduce accuracy or quality of the solutions or can lead to increased computational overhead (e.g., due to excessive iterations). For example, the learning models that implement a ReAct framework to solve a complex task may provide incorrect solutions, may terminate prematurely, and/or may become stuck in an iterative loop.

As described herein, to maintain or improve accuracy and quality of solutions to a task without increasing computational overhead, a learning model system can use a framework that includes a graph (e.g., referred to as a prompt graph or a knowledge graph), to perform a task using learning models. The learning model system can receive a prompt that includes a request for the learning models to perform the task (define a variable, answer a question, solve a puzzle, identify a root cause of a problem, etc.). The learning model system can generate a graph of relationships or dependencies between one or more terms in the prompt and one or more other terms related to the task. For example, if the task is to describe a variable in a segment of code, then the graph can include nodes for respective variables in the code that can be used to describe the variable and edges that define the relationships between the variables. The learning model system can receive user input that indicates the terms used for generating the graph and/or can otherwise obtain the terms used for generating the graph (e.g., if the terms are stored at a common database). The learning model system can provide the prompt as input to the learning models. The learning models can perform the task by traversing the graph of relationships between the terms and can generate a response to the prompt. Thus, the learning models operate within a boundary for the task defined by the graph, preventing or reducing premature termination, incorrect solutions, and/or iterative loops related to the learning models completing the task.

Generating a graph for performing a task using a learning model may reduce the use of computational resources (e.g., processing and memory resources) when compared with conventional frameworks for performing a task. For example, the learning model system can implement a graph to process a prompt within a defined criteria including the nodes and edges in the graph, which prevents the learning model from entering an infinite loop (e.g., being stuck in an iterative loop) while processing the prompt and/or reduces processing time by defining the scope of the processing using the graph. In some cases, processing the prompt within the defined criteria leads to improved accuracy in responses to the prompt by preventing or reducing premature termination of the processing of the prompt and by directing the learning model to a correct response via the graph.

In some implementations, the techniques described herein relate to a computer-implemented method including receiving a prompt for performing a task using a learning model, where the task includes a set of intermediate tasks, generating a graph to represent a set of relationships between at least one term included in the prompt and a set of additional terms associated with performing the task, where the graph includes a set of nodes corresponding to the at least one term and the set of additional terms, and a set of edges connecting the set of nodes, the set of edges corresponding to the set of relationships between the at least one term and the set of additional terms, performing, based on the graph, the set of intermediate tasks to obtain a response to the prompt, the set of intermediate tasks associated with the set of additional terms, removing one or more nodes of the set of nodes from the graph responsive to results of the set of intermediate tasks, and broadcasting the response to the prompt.

In some aspects, the techniques described herein relate to a computer-implemented method, where performing the set of intermediate tasks includes traversing the set of nodes via the set of edges to obtain respective intermediate tasks of the set of intermediate tasks, where the respective intermediate tasks are related to performing the task, performing, for respective additional terms of the set of additional terms, the respective intermediate tasks to obtain the results, and updating the graph based on the results.

In some aspects, the techniques described herein relate to a computer-implemented method, where updating the graph includes one or more of storing information associated with the respective additional terms at respective nodes of the set of nodes or storing a context of the respective additional terms at the respective nodes, and where the respective nodes correspond to the respective additional terms.

In some aspects, the techniques described herein relate to a computer-implemented method, where performing the set of intermediate tasks includes one or more of obtaining information associated with the set of additional terms or determining a context of the set of additional terms based on the set of relationships between the at least one term and the set of additional terms.

In some aspects, the techniques described herein relate to a computer-implemented method, where removing the one or more nodes is based on a size of the graph satisfying a threshold value.

In some aspects, the techniques described herein relate to a computer-implemented method, further including receiving user input that indicates the at least one term and the set of additional terms, where the at least one term and the set of additional terms include natural language values and parsing the user input to obtain the set of relationships between the at least one term and the set of additional terms.

In some aspects, the techniques described herein relate to a computer-implemented method, further including obtaining, based on accessing a database storing the set of additional terms and the at least one term, data indicating the at least one term and the set of additional terms, and parsing the data to obtain the set of relationships between the at least one term and the set of additional terms.

In some aspects, the techniques described herein relate to a computer-implemented method, where broadcasting the response to the prompt includes transmitting, to a computing device, the response to the prompt for display via a user interface of the computing device.

In some aspects, the techniques described herein relate to a computer-implemented method, where broadcasting the response to the prompt includes outputting, for display at a computing device, the response to the prompt via a user interface of the computing device.

In some aspects, the techniques described herein relate to a computer-implemented method, where the task includes one or more of a request for information corresponding to the at least one term, a request for context associated with the at least one term, or a request to define the at least one term.

In some aspects, the techniques described herein relate to a system including one or more processors, and a computer-readable storage medium storing instructions that are executable by the one or more processors to perform operations including receiving a prompt for performing a task using a learning model, where the task includes a set of intermediate tasks, generating a graph to represent a set of relationships between at least one term included in the prompt and a set of additional terms associated with performing the task, where the graph includes a set of nodes corresponding to the at least one term and the set of additional terms, and a set of edges connecting the set of nodes, the set of edges corresponding to the set of relationships between the at least one term and the set of additional terms, performing, based on the graph, the set of intermediate tasks to obtain a response to the prompt, the set of intermediate tasks associated with the set of additional terms, removing one or more nodes of the set of nodes from the graph responsive to results of the set of intermediate tasks, and broadcasting the response to the prompt.

In some aspects, the techniques described herein relate to a system, where to perform the set of intermediate tasks, the operations further include traversing the set of nodes via the set of edges to obtain respective intermediate tasks of the set of intermediate tasks, where the respective intermediate tasks are related to performing the task, performing, for respective additional terms of the set of additional terms, the respective intermediate tasks to obtain the results, and updating the graph based on the results.

In some aspects, the techniques described herein relate to a system, where to perform the set of intermediate tasks, the operations further include one or more of obtaining information associated with the set of additional terms or determining a context of the set of additional terms based on the set of relationships between the at least one term and the set of additional terms.

In some aspects, the techniques described herein relate to a system, where removing the one or more nodes is based on a size of the graph satisfying a threshold value.

In some aspects, the techniques described herein relate to a computer-implemented method including receiving a prompt for performing a task using a learning model, where the task includes a set of intermediate tasks, generating a graph to represent a set of relationships between at least one term included in the prompt and a set of additional terms associated with performing the task, performing, based on the graph, the set of intermediate tasks to obtain a response to the prompt, the set of intermediate tasks associated with the set of additional terms, and broadcasting the response to the prompt.

In some aspects, the techniques described herein relate to a computer-implemented method, where performing the set of intermediate tasks includes traversing the graph to obtain respective intermediate tasks of the set of intermediate tasks, where the respective intermediate tasks are related to performing the task, performing, for respective additional terms of the set of additional terms, the respective intermediate tasks to obtain results of the set of intermediate tasks, and updating the graph based on the results.

In some aspects, the techniques described herein relate to a computer-implemented method, where performing the set of intermediate tasks includes one or more of obtaining information associated with the set of additional terms or determining a context of the set of additional terms based on the set of relationships between the at least one term and the set of additional terms.

In some aspects, the techniques described herein relate to a computer-implemented method, further including receiving user input that indicates the at least one term and the set of additional terms, where the at least one term and the set of additional terms include natural language values and parsing the user input to obtain the set of relationships between the at least one term and the set of additional terms.

In some aspects, the techniques described herein relate to a computer-implemented method, further including obtaining, based on accessing a database storing the set of additional terms and the at least one term, data indicating the at least one term and the set of additional terms, and parsing the data to obtain the set of relationships between the at least one term and the set of additional terms.

In some aspects, the techniques described herein relate to a computer-implemented method, where broadcasting the response to the prompt includes transmitting, to a computing device, the response to the prompt for display via a user interface of the computing device, or outputting, for display at the computing device the response to the prompt via the user interface of the computing device.

### Example of an Environment

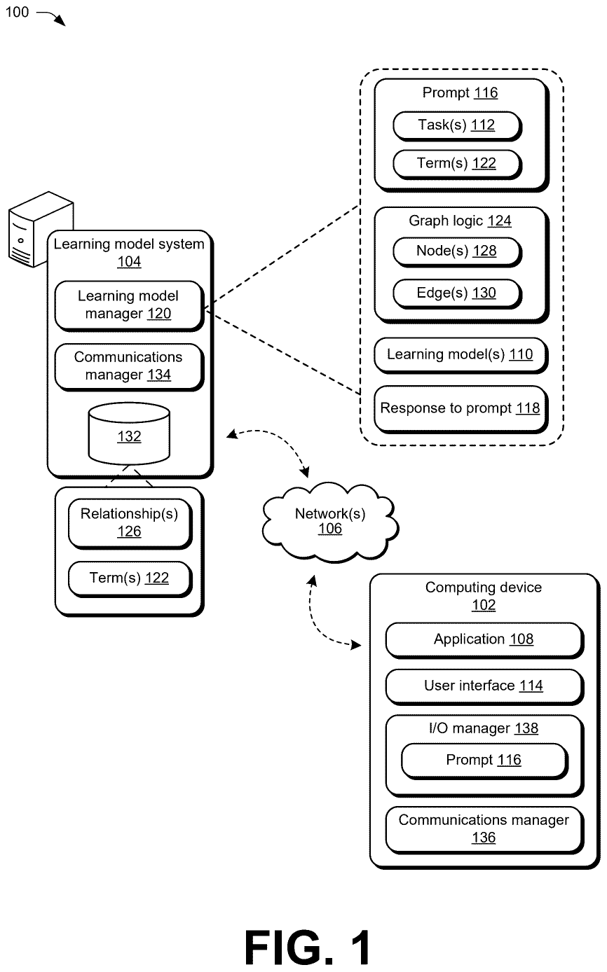

FIG. 1 is an illustration of an environment 100 in an example implementation that is operable to employ techniques described herein. The environment 100 includes a computing device 102 and a learning model system 104. In one or more implementations, the computing device 102 and the learning model system 104 are communicatively coupled, one to another, via network(s) 106. One example of the network(s) 106 is the Internet, although the computing device 102 and the learning model system 104 may be communicatively coupled using one or more different connections or different networks 106 (e.g., wireless networks) in various implementations.

Although the learning model system 104 is depicted in the environment 100 as being separate from the computing device 102, in one or more implementations, an entirety, or various portions of the learning model system 104 are implemented at or by the computing device 102. In at least one implementation, the learning model system 104 may be an example of a computing system that provides infrastructure and resources to support implementing artificial intelligence at a computing device 102. For example, the computing device 102 may run an application 108 via the learning model system 104 that implements one or more learning models 110. The learning model system 104 can use various resources of the computing device 102, such as hardware resources, an operating system, firmware, and so forth to process, distribute, and/or store data related to the application 108. Alternatively, or additionally, the learning model system 104 is implemented by server-based storage resources, processing resources, and so on of devices other than the computing device 102. For example, at least a portion of the learning model system 104 is implemented by hardware and software components including, but not limited to, servers, data storage systems, or networking equipment.

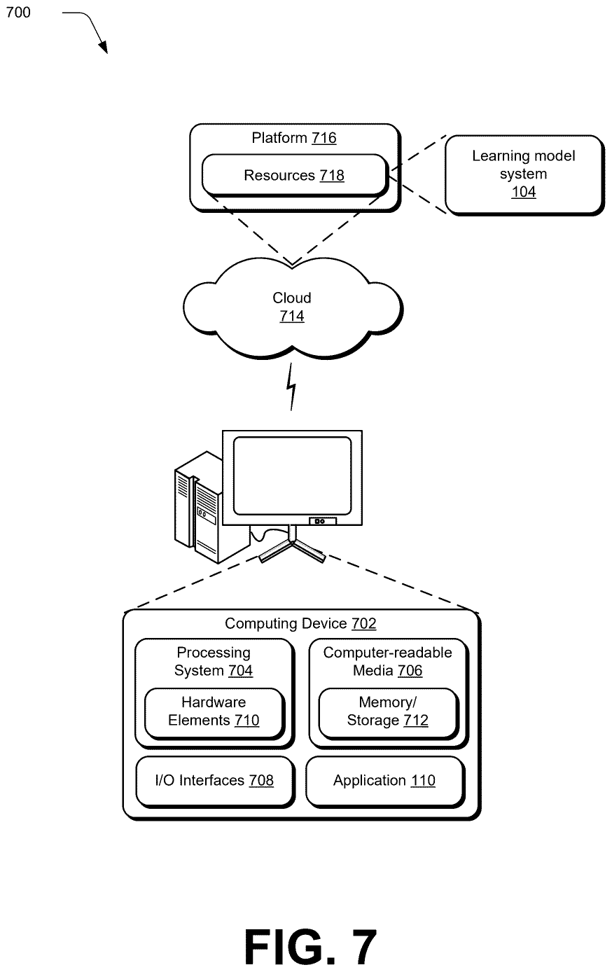

A computing device 102 is configurable in a variety of ways. A computing device, for instance, is configurable as a desktop computer, a laptop computer, a mobile device (e.g., assuming a handheld configuration such as a tablet or mobile phone), an IoT device, a wearable device (e.g., a smart watch, a ring, or smart glasses), an augmented reality and/or virtual reality device (e.g., the smart glasses), a server, and so forth. Thus, a computing device 102 ranges from full resource devices with substantial memory and processor resources to low-resource devices with limited memory and/or processing resources. Although in instances in the following discussion reference is made to a computing device 102 in the singular, a computing device 102 may also be representative of multiple different devices, such as multiple servers of a server farm utilized to perform operations “over the cloud” as described in relation to FIG. 7.

In at least one implementation, the application 108 supports communication of data across the network(s) 106 between the computing device 102 and the learning model system 104. By supporting such data communication, the application 108 provides a respective user of the computing device 102 (e.g., and users of other computing devices) access to different functionalities of the application 108. One example of the application 108 is a browser or other web application that facilitates user interaction with one or more features of the application 108. Another example of the application 108 is a web-based computer application that facilitates user interaction with one or more features of the application 108, such as a mobile application or a desktop application. The application 108 may be configured in different ways, which enable users to interact with the computing device 102 and by extension perform actions to interact with the features of the application 108, without departing from the spirit or scope of the techniques described herein.

For example, the application 108 may refer to a software program or system that incorporates one or more learning models 110 to perform tasks 112. The application 108 may utilize various types of algorithms, such as neural networks, decision trees, or support vector machines, to analyze data, make predictions, or generate outputs based on input information. In some examples, the application 108 may include components for data preprocessing, model training, inference, and result interpretation. The application 108 may interface with databases, user interfaces (e.g., a user interface 114 of the computing device 102), and other software systems to receive inputs and deliver outputs.

In some cases, the application 108 may be used to analyze and generate human language text. For example, the application 108 may power a chatbot that interprets user queries and provides relevant responses, or a content generation system that produces articles or reports on specified topics. Additionally, or alternatively, the application 108 may process and analyze visual data from images or video. For example, the application 108 may be used in a manufacturing setting to detect defects in products on an assembly line, or in a security system to identify and track individuals in surveillance footage. Additionally, or alternatively, the application 108 may analyze sensor data from machinery to predict when equipment is likely to fail or require maintenance, which provides for proactive scheduling of repairs and minimizes unexpected downtime. Additionally, or alternatively, e-commerce or streaming platforms may use learning model applications to analyze user behavior and preferences, providing tailored product or content recommendations to enhance user experience and increase engagement.

The computing device 102 can receive user input via a user interface 114 of the computing device 102. The user input can trigger an exchange of data between the computing device 102 and one or more other devices over the networks 106. The data can include a prompt 116 for the learning models 110 to complete one or more tasks 112. Example tasks 112 include, but are not limited to, text summarization, code generation, variable definition, language translation, root cause analysis, natural language question answering, image generation, sentiment analysis, entity recognition, text classification, data analysis, and dialogue generation, among other examples. Additionally, or alternatively, the data can include a response to the prompt 118. The response to the prompt 118 can include a solution or completion of the tasks 112. For example, the response to the prompt 118 can include, but is not limited to, a generated segment of code, a definition of a variable, a translation of natural language, a root cause of a failure, an answer to a natural language question, a generated image, a sentiment of natural language, an entity, a classification of a text, a report summarizing a data analysis, and generated dialog, among other examples.

The computing device 102 can display the user interface 114 via display devices or by making accessible voice-based user interfaces. Through interaction of a user with the computing device 102, the application 108 receives user input via the user interface 114. Examples of such input include, but are not limited to, receiving touch input in relation to portions of a displayed user interface, receiving one or more voice commands or other audio input, receiving typed input (e.g., via a physical or virtual (“soft”) keyboard), receiving mouse or stylus input, and so forth.

In some examples, the learning model system 104 can implement a learning model manager 120. The learning model manager 120 can be an example of software (e.g., logic) and/or hardware (e.g., processor and/or memory) that is configured to maintain and implement one or more learning models 110. The learning models 110 may refer to computational algorithms or systems designed to process input data, recognize patterns, and generate outputs or make decisions without being explicitly programmed for a specific task 112. The learning model manager 120 or another entity (e.g., a third-party computing system) may train the learning models 110 on relatively large datasets (e.g., greater than a threshold amount of data) to establish and/or improve a performance of the learning models 110. In some examples, the learning models may implement or include various types of artificial intelligence models and/or machine learning models, such as neural networks, decision trees, or support vector machines, which can be adapted to handle diverse tasks 112 ranging from natural language processing to image recognition. The learning models 110 may be examples of LLMs. LLMs are capable of understanding and generating a natural language response to a prompt 118. In some examples, the learning model manager 120 may implement any numerical quantity of learning models 110.

In some examples, LLMs implement a decoder-only transformer architecture. A decoder-only transformer architecture refers to a type of neural network model that utilizes a decoder component of an original transformer design. This architecture may process input sequences in a unidirectional manner, generating outputs token by token. In some cases, a decoder-only transformer architecture may employ self-attention mechanisms to analyze relationships between different parts of the input sequence. The decoder-only transformer architecture may use masked attention, where each token can attend to itself and the tokens that come before the token in the sequence, maintaining an autoregressive property. Decoder-only transformer architectures may be used for text generation, language modeling, and completion tasks, among other examples. Learning models 110 implementing a decoder-only transformer architecture may be trained on a relatively large corpora of text data (e.g., greater than a threshold amount of text data) to learn patterns and relationships in language that can be applied to various natural language processing tasks.

The learning model manager 120 may use the learning models 110 implementing the decoder-only transformer architecture across diverse language related tasks, ranging from comprehension to decision making. The learning model system 104 may implement a framework that combines reasoning and acting with the learning models 110, such as frameworks built upon a ReAct framework, to improve precisions and efficiency for interactive decision making. The ReAct framework is a prompt-based paradigm aimed at synergizing reasoning and acting in LLMs for general task solving. The ReAct framework may lead to delineating a distinct action, âₜ, within a language space, L(âₜ∈L), which aims to compose useful information by processing using a current context, cₜ, and update the context cₜ₊₁=(cₜ, âₜ) to support future processing or acting. While the ReAct framework demonstrates efficacy in navigating simple decision making tasks, the ReAct framework encounters challenges when confronted with complex scenarios with large action space, L. In such instances, learning models implementing the ReAct framework often terminate prematurely or breach an input length threshold for in-context learning.

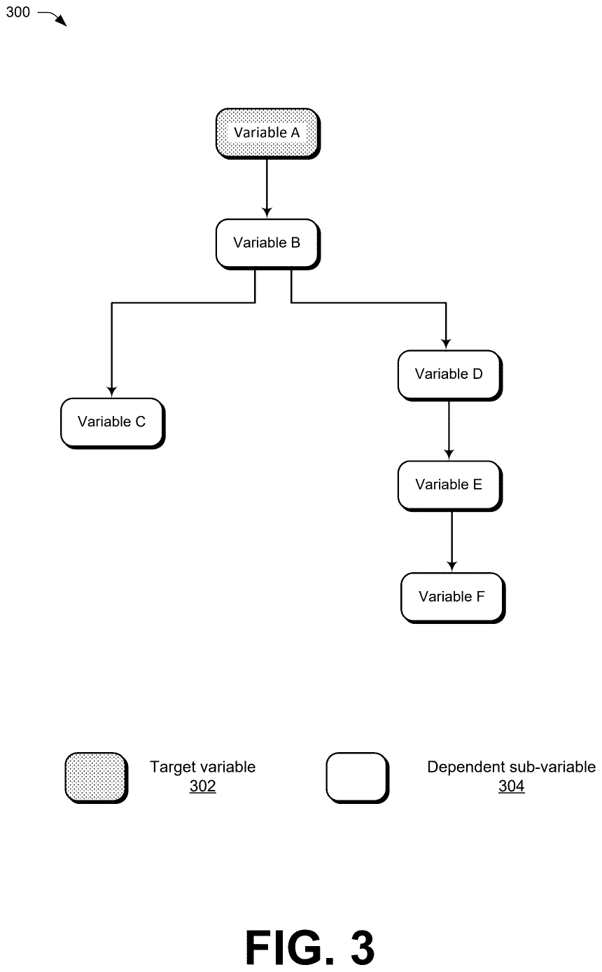

While the ReAct framework excels in straightforward ad-hoc scenarios, the ReAct framework encounters challenges when confronted with more intricate cases. For example, using the ReAct framework to perform a root cause analysis task may include a risk domain involving elements such as checkpoints, actions, sites, and rules. When dealing with an anomaly in a checkpoint indicator, the ReAct framework includes analyzing which actions are affected, identifying problematic sites, and analyzing which rules triggered the anomaly. However, when the ReAct framework attempts to autonomously reason through this process, the learning models 110 often terminate prematurely, provide incorrect answers, or get stuck in loops among several elements. In some other examples, the learning model system 104 may attempt to use the ReAct framework to perform a variable description task, also referred to as a variable definition task. A risk decision engine encompasses a relatively large numerical quantity of variables (e.g., greater than a threshold, up to 17,000 variables). The variables have inter-dependencies, which is described in further detail with respect to FIG. 3. The variable definition task can include understanding and summarizing logic behind a variable by comprehending and summarizing dependent sub-variables.

For example, a task 112 may be to define a variable, buyer_email_risk_score, by comprehending and summarizing the sub variables risk_metrics_buyer_trans, buyer_credit_card_token, buyer_complete_nlln_addr, buyer_nlln_billing_addr, and buyer_billing_addr. The variables risk_metrics_buyer_trans may depend directly from buyer_email_risk_score. The variables buyer_credit_card_token and buyer_complete_nlln_addr may depend directly from risk_metrics_buyer_trans, the variable buyer_nlln_billing_addr may depend directly from buyer_complete_nlln_addr, and the variable buyer_billing_addr may depend directly from buyer_nlln_billing_addr. However, when attempting to guide the ReAct framework to engage in continuous reasoning based on this logic, the ReAct framework may not terminate and/or may terminate prematurely after summarizing one path. For example, if the variables buyer_credit_card_token and buyer_complete_nlln_addr both depend directly from risk_metrics_buyer_trans, then the ReAct framework may terminate after summarizing one of buyer_credit_card_token and any corresponding sub-variables or buyer_complete_nlln_addr and the corresponding sub-variables (e.g., buyer_nlln_billing_addr and buyer_billing_addr).

As described herein, to reduce premature termination or failure to terminate of a learning model 110 (e.g., for root cause analysis tasks and variable definition tasks, among other examples), the learning model manager 120 may implement a graph to link relationships among system elements when processing a prompt 116. For example, integrating knowledge graphs and graph operations into the processing of a prompt 116 by one or more learning models 110 enables the learning models 110 to improve utilization of associative information among elements (e.g., terms 122) during the processing. Consequently, implementing a graph during processing of a prompt 116 enhances the stability and accuracy of the learning models 110 in performing tasks 112.

The learning model system 104 may receive a prompt 116 from a computing device 102 via the networks 106. The prompt 116 can include one or more terms 122 that define a task 112. For example, if the task 112 is to define a variable (e.g., buyer_email_risk_score), then the terms 122 can include the variable to be defined, as well as any sub-variables related to the variable. The learning model manager 120 may implement graph logic 124 to generate a graph (e.g., a knowledge graph). A knowledge graph may refer to a structured representation of information that captures relationships 126 between various terms 122 (e.g., concepts or entities) relevant to performing a task 112. The knowledge graph may include nodes 128 and edges 130 connecting the nodes 128. Each term 122 may be represented by a node 128, and the edges 130 define the relationships 126 between the terms 122. For example, if the task 112 is variable definition for a variable A with sub-variables B and C, then the nodes 128 may include a node 128 for variable A, a node 128 for variable B, and a node 128 for variable C. The edges 130 may link the variables A, B, and C in a manner that defines the relationship 126 (e.g., parent or child) for the respective nodes 128, which is described in further detail with respect to FIG. 3. The graph structure may provide for efficient organization, traversal, and retrieval of information relevant to the task 112.

The graph logic 124 may provide a framework for guiding learning models 110 to perform a task 112. For example, the graph logic 124 defines a bounded context within which the learning models 110 operate, helping to maintain coherence and relevance in an output of the learning models (e.g., the response to the prompt 118). As the learning models 110 process a prompt 116 and perform intermediate tasks 112, the learning models 110 may traverse the knowledge graph, utilizing the relationships defined within the knowledge graph to obtain relevant information, process the information to obtain an intermediate result, and generate a response to the prompt 118. The graph logic 124 may include dynamic updates to the knowledge graph based on the results of intermediate tasks, with nodes 128 being added or removed to reflect new information or to manage a complexity of the knowledge graph. In some examples, the dynamic updates to the knowledge graph may be based on the complexity of the task 112. For example, the learning model system 104 may prune unnecessary nodes or merge related concepts to maintain a defined graph size and improve processing efficiency.

In some examples, the learning model system 104 may obtain relationships 126 between nodes 128 and/or one or more terms 122 (e.g., additional terms 122 relevant to a term 122 in the prompt 116). For example, the learning model system 104 may receive user input that indicates the terms 122 and the relationships 126 (e.g., via the computing device 102). The user input may be in the form of natural language descriptions, which the system then parses to extract the relationships between terms 122. Additionally, or alternatively, the learning model system 104 may access a database storing one or more defined terms 122 and the corresponding relationships 126 between the terms 122. The database may be populated with domain-specific knowledge or general-purpose information relevant to the tasks 112 the learning model system 104 is designed to process. Additionally, or alternatively, the learning model system 104 may employ natural language processing techniques to automatically extract relationships 126 from a large corpora of text data. The natural language processing techniques may include analyzing sentence structures, identifying semantic relationships, or using pre-trained models for relation extraction. Additionally, or alternatively, the learning models 110 may infer relationships 126 between terms 122 based on their co-occurrence patterns in training data or their usage in similar contexts. Additionally, or alternatively, the system may integrate with external knowledge bases or interfaces (e.g., application programming interfaces (APIs)) to retrieve relationships 126 for a set of terms 122. By accessing external databases or APIs to enhance a graph, the learning model system 104 may adapt and improve over time.

As the learning model system 104 performs tasks 112, the learning model system 104 may update and refine the relationships 126 in the graph based on the results of intermediate tasks and any additional information encountered. The learning model system 104 may store the relationships 126 and the terms 122 at a data storage 132. The data storage 132 may be an example of memory at the learning model system 104, a memory system external to the learning model system 104, or any other form of data storage. In some examples, the learning model system 104 may store (e.g., cache) intermediate results or frequently accessed nodes 128 to speed up subsequent queries on related topics.

In some examples, learning model system 104 and the computing device 102 implement a communications manager 134 and a communications manager 136, respectively, to support communication of data across the network(s) 106 between the computing device 102 and the learning model system 104. By supporting such data communication, the communications manager 134 and the communications manager 136 provide for the computing device and the learning model system 104 to exchange data related to an application 108 for processing, storage, and/or distribution. The data can include, but is not limited to, the prompt 116, the response to the prompt 118, the relationships 126, and the terms 122, among other data.

The computing device 102 can receive user input via an I/O manager 138 that causes the computing device 102 to execute instructions, such as to cause the computing device 102 to transmit or receive data to and from the learning model system 104. For example, the computing device 102 can receive user input (e.g., the prompt 116) via the user interface 114, and the I/O manager 138 triggers the computing device 102 to transmit data (e.g., including the prompt 116) to the learning model system 104. Additionally, or alternatively, the I/O manager 138 may configure the computing device 102 to display, or otherwise present, controls that are selectable by a user to provide user input requesting user input. In some examples, the I/O manager 138 display the controls to the user via a graphical user interface (GUI) of a computing device 102 (e.g., via the user interface 114). For example, the I/O manager 138 can display the response to the prompt 118 via a user interface 114 of the computing device 102. In some other examples, the I/O manager 138 display the response to the prompt 118 to the user via a GUI of another device communicatively coupled with the computing device 102 (e.g., another computing device coupled via the networks 106). The I/O manager 138 can visually display the controls (e.g., the prompt 116, the response to the prompt 118, and/or features of the application 108), can emit an audio version of the controls via an audio output component, or the like.

The learning model system 104 may implement the learning model manager 120 and the communications manager 134 by using servers that execute stored instructions to deploy various services of the learning model system 104, such that those services perform numerous computations which are effective to provide the functionality described above and below. It is to be appreciated that the learning model system 104 and the computing device 102 may include more, fewer, or different components without departing from the spirit or scope described herein.

Having considered an example of an environment, consider now a discussion of some example details of the techniques for processing of a prompt 116 to obtain an output using a graph in accordance with one or more implementations.

### Processing of a Prompt to Obtain an Output Using a Graph

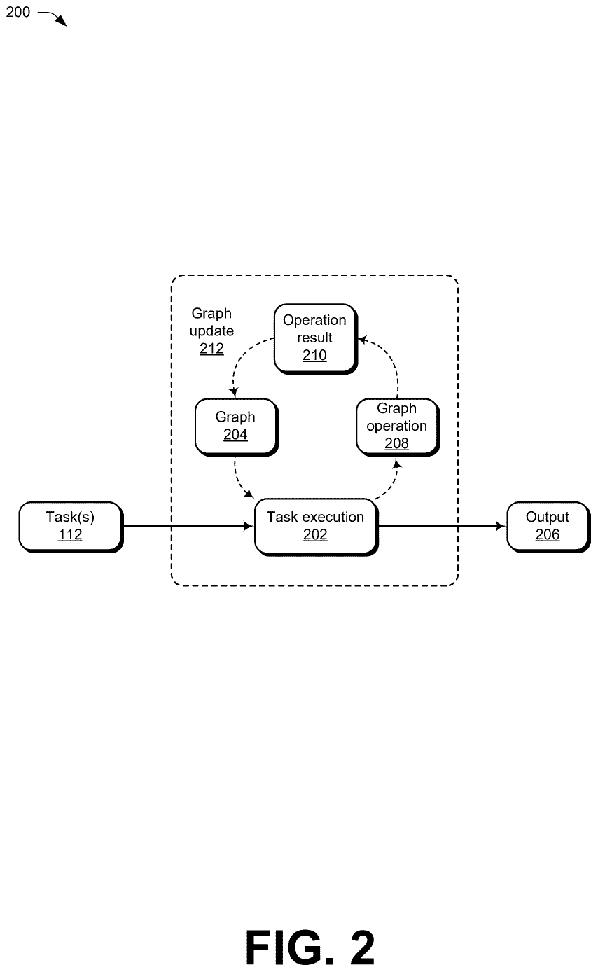

FIG. 2 depicts an example diagram 200 of processing of a prompt to obtain an output using a graph. The diagram 200 can be implemented by aspects of the environment 100. For example, the diagram 200 can be implemented by a learning model system, which may be an example of the learning model system 104, as described with reference to FIG. 1.

In some examples, the learning model system 104 may implement learning models to complete (e.g., perform or execute) tasks 112. The tasks 112 may be examples of the tasks 112 as described with reference to FIG. 1. The learning model system may obtain a prompt. For example, the learning model system may receive signaling from a computing device that indicates the prompt. Additionally, or alternatively, the learning model system may be implemented at the computing device, and the learning model system may obtain the prompt directly from a user interface of the computing device.

The learning model system may parse the prompt to determine one or more tasks 112. For example, the learning model system may implement natural language processing techniques to analyze the structure and content of the prompt. The natural language processing techniques may include tokenization, part-of-speech tagging, and syntactic parsing to identify key components such as action verbs, objects, and modifiers that indicate the tasks 112. Additionally, or alternatively, the learning model system may utilize defined patterns or templates to recognize common task structures within prompts. For example, the learning model system may identify phrases (e.g., define, explain, or compare) as indicators of specific task types. Additionally, or alternatively, the learning model system may apply named entity recognition to identify and categorize entities within the prompt that may be relevant to task identification, such as specific terms, concepts, or domain-specific vocabulary. Additionally, or alternatively, the learning model system may implement semantic role labeling techniques to identify the relationships between different portions of the prompt, which provide for the learning model system to determine the roles of various elements in defining the tasks 112. Additionally, or alternatively, the learning model system may employ a classification model trained on a diverse set of prompts and their corresponding tasks 112. The classification model may categorize new prompts into predefined task types or extract relevant task information from the prompts. In some cases, the system may use a combination of the example parsing methods, applying them sequentially or in parallel to extract and validate task information from the prompt.

In some examples, the action space, L, for a task 112 may be relatively large (e.g., greater than a threshold). An action space for a task 112 refers to a set of actions or operations that can be performed by one or more learning models or a learning model system in the context of task execution 202 for a task 112. The action space may encompass a range of intermediate steps, decisions, or manipulations that the learning models can execute as the learning models works towards generating a response to a prompt (e.g., by solving, executing, processing a task 112). In some cases, the action space may be finite or infinite, depending on the nature of the task and the capabilities of the learning models.

Conventional techniques for task execution 202 (e.g., using the ReAct framework) for a task 112 with an expansive action space result in an inability for the learning models to control distinct actions, âₜ, often exceeding the input length limit of in-context learning.

In some examples, to provide for learning models to perform task execution 202 for a relatively complex task 112 (e.g., a task 112 with an action space that exceeds a threshold size), a learning model system may implement a graph 204. Thus, the action space for solving the task 112 may include operations such as retrieving information from a graph 204 (e.g., a graph, Gₜ), performing calculations, generating text, or modifying the structure of the graph 204. In some examples, the action space may be constrained by nodes and edges present in the graph 204, helping to define the boundaries within which the learning models can operate to complete the task 112 efficiently and accurately. The graph 204 may be referred to as a prompt graph or a knowledge graph and may depict interrelationships among various elements within complex scenarios. Guiding learning models to process tasks using the information within the graph 204 leads to improvements in logic and control for processing prompts to perform (e.g., execute) tasks 112 within complex scenarios.

In some examples, the learning model system may construct (e.g., generate) a graph 204 for a given task 112. For example, the learning model system may obtain a prompt, parse the prompt to determine at least one task 112, and construct a graph 204 for the determined task 112. The graph 204 represents the interrelationships among various elements within a scenario defined by the task 112. An example graph 204 for a variable definition task is described in further detail with respect to FIG. 3.

Generating or constructing the graph 204 can include, but is not limited to, node identification, edge creation, hierarchical structuring, attribute assignment, graph expansion, relationship weighting, and graph optimization. For example, the learning model system may analyze the prompt and associated task 112 to identify relevant terms or concepts that will form the nodes of the graph 204. This may involve natural language processing techniques to extract key entities and terms. The learning model system establishes relationships between the identified nodes, forming the edges of the graph 204. The relationships may be determined based on predefined rules, semantic analysis, or information retrieved from one or more databases. The learning model system may organize nodes in a hierarchical manner, establishing parent-child relationships or levels of abstraction within the graph 204.

In some cases, the learning model system may assign nodes and edges attributes or properties that provide additional context or information relevant to the task 112. Example attributes may include, but are not limited to, a priority level of the task 112, a complexity (e.g., difficulty, intricacy) of the task 112, an expected duration to complete the task 112, other tasks 112 or conditions to perform before this task 112 can be executed, tools, data, or computational resources for the task 112, variables or information to use as input for the task 112, an expected format or structure of the result of the task 112 (e.g., the output 206), boundaries within which the task 112 is to be performed, subtasks (e.g., intermediate tasks 112) that include smaller components or steps that make up a larger task 112, metrics or conditions that define successful completion of the task 112, guidelines for managing potential errors or exceptions, a domain or category of the task 112 (e.g., field or area of knowledge to which the task 112 belongs), and access levels or authorizations required to perform the task 112, among other examples. Once an initial graph 204 is constructed, the learning model system can expand the graph 204 by incorporating related terms or concepts not explicitly mentioned in the prompt but relevant to a context of the task 112. In some examples, edges may be assigned weights to represent the strength or importance of relationships between nodes. The learning model system may prune unnecessary nodes or consolidate redundant information to maintain an efficient and relevant graph structure.

Further, the learning model system may dynamically update the graph 204 during the process of task execution 202. During the process of task execution 202 at each time step, t, the learning models generate an intermediate outcome, \hat{r}ₜ, based on a task 112 and the interrelationships contained in the graph 204. The learning model system performs (e.g., executes) a graph operation 208 to transform the generated intermediate outcome into a specific operation on the graph 204, denoted as \hat{r}ₜ→oₜ. If the target operation is the final response to the prompt (e.g., the output 206, the solution to the task 112), then the learning model system terminates the loop and returns the output for the task 112. Otherwise, the learning model system executes the operation, oₜ, and obtains an operation result 210,

$${o}_{t}^{result} .$$

The learning moder system performs a graph update 212 to update the graph 204 to Gₜ₊₁ based on the operation result 210, denoted as

$${G}_{t + 1} ← ( {G}_{t} , {o}_{t}^{result} ) .$$

Once the graph 204 is updated, then the learning model system continues to perform the task execution 202 until the output 206 is obtained.

The task execution 202 algorithm is shown in Table 1.

TABLE 1
Task execution algorithm

| Input: | task |
|---|---|
| 1: | Initial Prompt Graph G₀ |
| 2: | Initial Operation Set O |
| 3: | t ← 0 |
| 4: | repeat |
| 5: | rₜ ← LLM · predict(task, Gₜ){generate intermediate outcome |
| | within the Prompt Graph Gₜ} |
| 6: | ${o}_{t} , {o}_{t}^{input} ← LLM \cdot predict ( {r}_{t} , O ) \{ transform intermediate outcome$ |
| | into graph operation oₜ} |
| 7: | ${o}_{t}^{result} ← {o}_{t} \cdot exec ( {o}_{t}^{input} )$ |
| 8: | ${G}_{t + 1} ← ( {G}_{t} , {o}_{t}^{result} )$ |
| 9: | t ← t + 1 |
| 10: | until oₜ = final_response |
| 11: | $final\_response ← {o}_{t}^{input}$ |
| Output: | final_response |

In some examples, the learning model system may provide the graph information to the learning models to enable the learning models to accurately understand the interrelationships among various elements in the graph 204. For example, the learning model system may use a resource description framework (RDF) to describe the graph 204. RDF is a model for data interchange that extends a linking structure of the Internet to use uniform resource identifiers (URIs) to name the relationship between terms, as well as the two ends of the link. RDF provides for structured and semi-structured data to be mixed, exposed, and shared across different applications. RDF may provide a flexible way to describe relationships between nodes, enabling complex queries and inferences across interconnected data. In some cases, the learning model system may directly use RDF text as a prompt for the learning models rather than obtaining embeddings of the graph and using these embeddings as inputs to the learning model.

By using the RDF text as a prompt for the learning models, the learning model system does not rely on other models or specific graphs, nor does the learning model system perform fine-tuning of the learning models. Further, RDF uses a triple structure to express graph information, which means that the learning model system can perform operations like modification, addition, or deletion of graph elements. An example of task execution using a graph 204 is described in further detail with respect to FIG. 3.

FIG. 3 depicts an example graph 300 depicting relationships between variables for learning model task performance. The graph 300 can be implemented by aspects of the environment 100 and/or the diagram 200. For example, the graph 300 can be implemented by a learning model system 104, as described with reference to FIG. 1.

The graph 300 illustrates an example of a prompt graph or knowledge graph for a variable definition task. For example, the graph 300 includes a target variable 302 and one or more dependent sub-variables 304 that depend from the target variable 302. Although the graph 300 illustrates an example of a single target variable 302, there may be any numerical quantity of target variables 302. Further, there may be any numerical quantity of sub-variables, where the sub-variables may be interrelated in any manner.

Variable A is an example of a target variable 302, while Variable B through Variable F are examples of sub-variables. A sub-variable may refer to a variable that is dependent on or derived from another variable within a hierarchical structure or relationship. Sub-variables may represent more specific or granular aspects of a parent variable, contributing to a more detailed or nuanced representation of a concept or entity within a system or model. Variable B may be a dependent sub-variable 304 of Variable A, Variable C and Variable D may be dependent sub-variables 304 of Variable B (e.g., and therefore also Variable A), Variable E may be a dependent sub-variable 304 of Variable D, and Variable F may be a dependent sub-variable 304 of Variable E.

In some examples, a learning model system may implement the graph 300 to provide for learning models to execute (e.g., perform, complete) a task, as described with reference to FIGS. 1 and 2. For example, the task execution may include constructing the graph 300, performing a graph operation to obtain an operation result, updating the graph 300, and repeating until the learning models produce an output or final response. Example graph operations for variable definition are shown in Table 2.

TABLE 2
Graph operations for variable description

| Operation | Description | Scope |
|---|---|---|
| Expand | To retrieve the linked | This operation adds new nodes |
| | nodes of a specified | that are linked to the target node |
| | node and update the graph. | |
| Describe | To generate a description | This operation enriches the |
| | for the specified node. | properties of the target node |

For example, the learning model may obtain variable dependency from the graph 300 and perform an operation describe Variable F. The result of the operation may be a description of the Variable F. For example, if the Variable F is buyer_billing_addr, then the description may be “Get the billing address of a given payment instrument. Service data source is ‘xyz.’” The following operations may be to describe Variable E, Variable D, Variable C, and Variable B. A final operation may be to describe the target variable 302, Variable A. The result of the final operation may be a description for Variable A. For example, if the Variable A is buyer email_risk_score, then the description may be “Get the risk score of the buyer email used in the transaction.”

To generate a solution or output based on a task and the interrelationships in the graph 300, the learning model system may utilize system prompts to provide guiding principles to the learning models. The learning model system may implement in-context learning to direct the learning models to process the task based on the interrelationships within the graph 300 and the provided principles. In-context learning refers to a technique where a learning model performs tasks using information provided within a prompt, without explicit fine-tuning or retraining. The learning model may execute tasks by leveraging contextual cues and examples provided in the prompt.

In some cases, principles set for each task may vary. For example, in the variable definition task, the principles may include summarizing the sub-variables first and defining graph operations for different scenarios, where the operation is set for variables. For a variable definition task, the learning model may process the task using an initial variable dependency graph under the guidance of prompts. The learning models may progressively identify sub-variables that can be summarized and perform a describe operation for the sub-variables. The resulting descriptions are then updated in the initial variable dependency graph until the description of the target variable is complete.

In some examples, a size of the graph 300 or any other graph implemented by the learning model system may exceed a threshold value. For example, a numerical quantity of nodes in the graph 300 may exceed a threshold value. The threshold value may be based on a storage capacity of the learning model system and/or a computing device implementing the learning model system. Additionally, or alternatively, the threshold value may be based on a processing capability of the learning model system and/or the computing device, a desired performance (speed of processing, battery consumption, etc.) of the learning model system and/or the computing device, or any other factors. For example, an excessive number of nodes may result in increased inference by learning models, which is time-consuming. Thus, the learning model system may implement dynamic updates to the graph 300. The dynamic updates can include graph pruning (e.g., removing nodes from the graph 300) and/or bulk operations.

Graph pruning can include removing nodes for which an intermediate task is performed (e.g., dependent sub-variables 304 that are already defined for a variable definition task) after each update to reduce a size of the graph 300. Different pruning methods are applied based on a type of task. For example, in the variable definition task, when a variable node already has a description, then the learning model system removes all dependent sub-variable nodes. To improve the efficiency of graph operations, the learning model system may implement bulk operations. Bulk operations provide for multiple nodes to be processed simultaneously. For example, the bulk operations enable the simultaneous update of multiple node states, reducing the number of inferences performed by the learning models and improving efficiency. With graph pruning and bulk operations, the learning model system manages a scale of the graph 300 and enhances efficiency of graph operations.

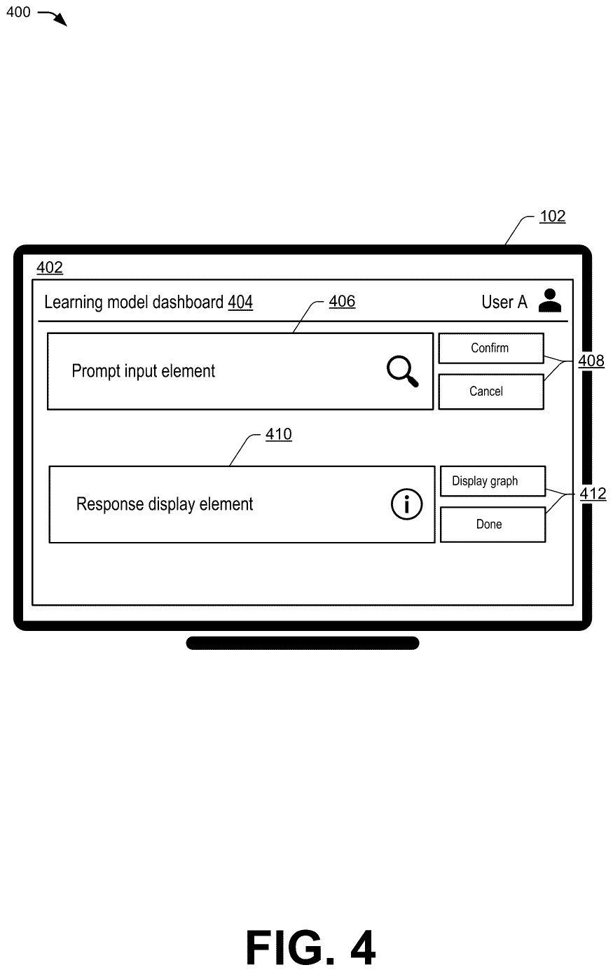

FIG. 4 depicts an example 400 of a user interface for learning model task performance using a graph. The example 400 can be implemented by aspects of the environment 100, the diagram 200, and/or the graph 300. For example, the example 400 can be implemented by a computing device 102 and/or a learning model system (e.g., a learning model system 104), as described with reference to FIG. 1.

The example 400 includes a user interface 402 of a computing device 102. The user interface 402 can be an example of a GUI. The computing device 102 can display a learning model dashboard 404 of an application. The learning model dashboard 404 may provide a prompt input element 406 selectable by a user to provide a prompt. For example, the prompt input element 406 may include an option for the user to provide text input and/or image input, where the prompt includes natural language text and/or an image. Once the user provides the prompt as input to the prompt input element 406, then the user may select an interactive element 408. The interactive elements 408 may include an option to confirm the input of the prompt and an option to cancel the input of the prompt.

If the user provides user input to select the interactive element 408 with the option to confirm the input of the prompt, then the learning model system may obtain the prompt from the computing device 102 (e.g., over a network if the learning model system is implemented independent of the computing device 102 or an internal processor of the computing device 102 if the learning model system is implemented at the computing device 102). The learning model system may process the prompt to obtain the output, as described with reference to FIGS. 1 through 3. If the user provides user input to select the interactive element 408 with the option to cancel the input of the prompt, then the learning model system may not obtain the prompt.

The computing device 102 may obtain the output responsive to the prompt (e.g., a solution or execution of a task) from the learning model system. For example, the learning model system 104 may broadcast the response to the prompt to the computing device 102 and/or to a user via the user interface 402. That is, broadcasting the response to the prompt can include a transmission of data including the response to the prompt between physical devices via a network. Additionally, or alternatively, broadcasting the response to the prompt can include displaying the response to the prompt via a user interface 402 of a computing device 102. The computing device 102 may display the output via the user interface 402. For example, the computing device 102 may use the response display element 410 to display the output. The user interface 402 may include additional interactive elements 412 that provide for a user to select an option to display the graph or to terminate the task completion process and/or the display of the output.

In some examples, the learning model dashboard 404 may be unique for respective users. For example, a User A may have a customized prompt input element 406 and/or a response display element 410 based on a configuration of the learning model dashboard 404.

In some examples, the user interface 402 may include a layout with multiple panes or windows that visually represents the process of obtaining a response to a prompt using a graph. The user interface 402 may display the prompt input element 406 for entering the prompt, alongside a dynamic visualization of the generated graph. As the system processes the prompt, the graph may update in real-time, showing nodes being added, removed, or modified. The user interface 402 may also include interactive elements that enable users to manipulate the graph directly. For example, users may select nodes to expand sub-variables, adjust edge weights to influence relationships, or add constraints to guide the reasoning process. A separate pane may display intermediate results as the system traverses the graph, providing insights into each step of the task performance. The final output may be presented at the response display element 410, with options to export the results or the entire reasoning process.

Having discussed exemplary details of learning model task performance using a graph, consider now some examples of procedures to illustrate additional aspects of the techniques.

### Example Procedures

This section describes examples of procedures for learning model task performance using a graph. Aspects of the procedures may be implemented in hardware, firmware, or software, or a combination thereof. The procedures are shown as a set of blocks that specify operations performed by one or more devices and are not necessarily limited to the orders shown for performing the operations by the respective blocks.

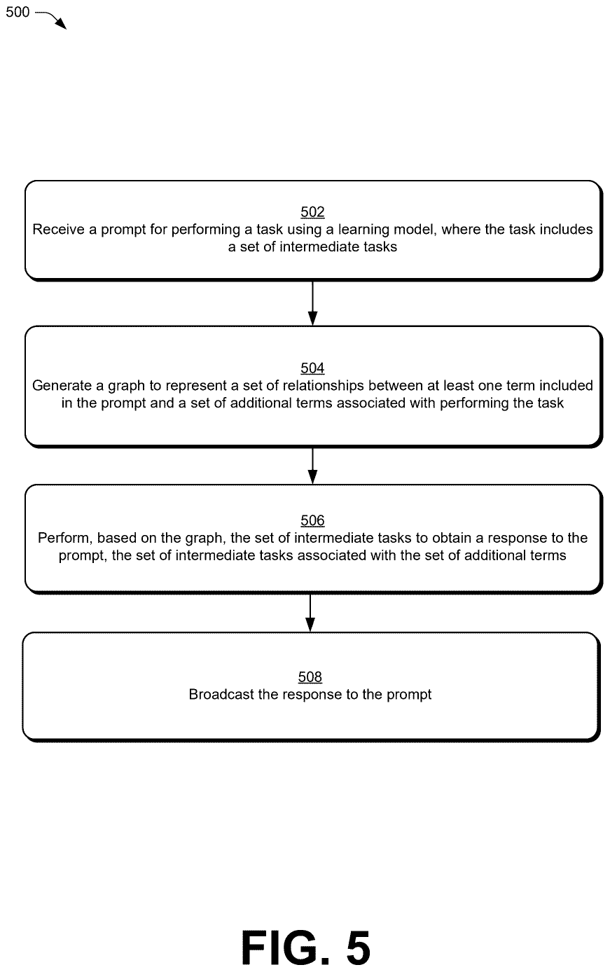

FIG. 5 depicts a procedure 500 in an example implementation of learning model task performance using a graph. Aspects described as being performed by a learning model system can additionally, or alternatively, be performed by a computing device.

At 502, a prompt for performing a task using a learning model is received, where the task includes a set of intermediate tasks. In some cases, the task may include variable definition (e.g., in software development), including, but not limited to, defining complex variables with multiple dependencies, explaining the purpose and usage of variables in large codebases, and tracing variable relationships across different modules or classes. In some other cases, the task may include root cause analysis (e.g., in system diagnostics). For example, the task may include identifying a source of failures in distributed computing systems, analyzing error logs to determine the origin of cascading failures, and tracing performance bottlenecks in microservice architectures. Additionally, or alternatively, the task may include natural language processing, including, but not limited to, performing multi-step processing for question answering, generating coherent long-form content with consistent context, and summarizing complex documents while maintaining key relationships between concepts. Additionally, or alternatively, the task may include financial analysis and risk assessment, including, but not limited to, evaluating credit risk by analyzing interconnected financial factors, detecting potential fraud patterns in transaction networks, and forecasting market trends based on multiple economic indicators. The task may include any of the examples provided, as well as any other types of tasks that result in processing complex relationships between multiple factors.

At 504, a graph is generated to represent a set of relationships between at least one term included in the prompt and a set of additional terms associated with performing the task.

At 506, the set of intermediate tasks is performed based on the graph to obtain a response to the prompt, where the set of intermediate tasks is associated with the set of additional terms.

For example, one or more learning models may traverse the graph to obtain respective intermediate tasks (e.g., graph operations). The respective intermediate tasks are related to performing the task, such as defining sub-variables of a target variable, as described with reference to FIG. 3. The learning models may perform the respective intermediate tasks for respective additional terms to obtain results of the intermediate tasks. The learning models and/or the learning model system may update the graph based on the results.

In some cases, the learning model system obtains information about the additional terms, such as by parsing a prompt to obtain the information and/or accessing a database to obtain the information, among other examples. Additionally, or alternatively, the learning model system determines a context of the additional terms using relationships between the term in the prompt (e.g., a target variable) and the additional terms (e.g., sub-variables of the target variable).

In some cases, the learning model system receives user input that indicates the term and the additional terms, where the at term and the additional terms include natural language values or text. The learning model system parses the user input to obtain the relationships between the term and the additional terms. In some other cases, the learning model system obtains data indicating the term and the additional terms by accessing a database storing the additional terms and the term. The learning model system parses the data to obtain the relationships between the term and the additional terms.

At 508, the response to the prompt is broadcasted. In some cases, broadcasting the prompt includes transmitting the response to the prompt to a computing device for display via a user interface of the computing device. Additionally, or alternatively, broadcasting the prompt includes outputting the response to the prompt for display at the computing device via the user interface of the computing device.

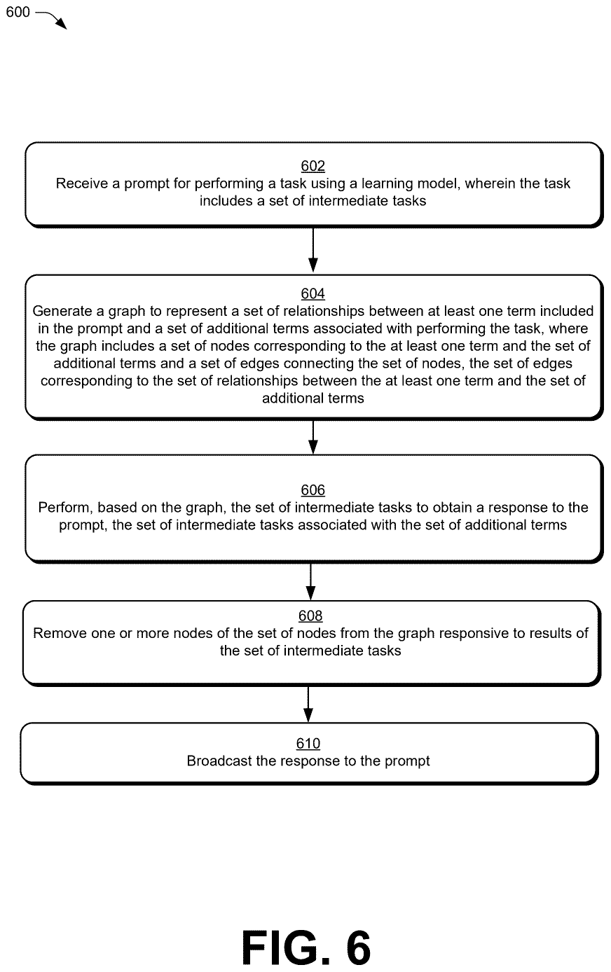

FIG. 6 depicts a procedure 600 in an example implementation of learning model task performance using a graph. Aspects described as being performed by a learning model system can additionally, or alternatively, be performed by a computing device.

At 602, a prompt for performing a task using a learning model is received, where the task includes a set of intermediate tasks. In some cases, the task includes one or more of a request for information corresponding to the at least one term, a request for context associated with the at least one term, or a request to define the at least one term.

At 604, a graph is generated to represent a set of relationships between at least one term included in the prompt and a set of additional terms associated with performing the task, where the graph includes a set of nodes corresponding to the at least one term and the set of additional terms and a set of edges connecting the set of nodes, the set of edges corresponding to the set of relationships between the at least one term and the set of additional terms.

At 606, the set of intermediate tasks is performed based on the graph to obtain a response to the prompt, where the set of intermediate tasks is associated with the set of additional terms.

For example, one or more learning models may traverse the nodes via the edges to obtain respective intermediate tasks (e.g., graph operations). The respective intermediate tasks are related to performing the task, such as defining sub-variables of a target variable, as described with reference to FIG. 3. The learning models may perform the respective intermediate tasks for respective additional terms to obtain results of the intermediate tasks. The learning models and/or the learning model system may update the graph based on the results. In some cases, updating the graph includes storing information of the respective additional terms at respective nodes and/or storing a context of the respective additional terms at the respective nodes. The respective nodes correspond to the respective additional terms.

In some cases, the learning model system obtains information about the additional terms, such as by parsing a prompt to obtain the information and/or accessing a database to obtain the information, among other examples. Additionally, or alternatively, the learning model system determines a context of the additional terms using relationships between the term in the prompt (e.g., a target variable) and the additional terms (e.g., sub-variables of the target variable).

In some cases, the learning model system receives user input that indicates the term and the additional terms, where the at term and the additional terms include natural language values or text. The learning model system parses the user input to obtain the relationships between the term and the additional terms. In some other cases, the learning model system obtains data indicating the term and the additional terms by accessing a database storing the additional terms and the term. The learning model system parses the data to obtain the relationships between the term and the additional terms.

At 608, one or more nodes of the set of nodes are removed from the graph responsive to results of the set of intermediate tasks. For example, the learning model system removes the nodes if a size of the graph satisfies (e.g., is greater than, exceeds) a threshold value.

At 610, the response to the prompt is broadcasted. In some cases, broadcasting the prompt includes transmitting the response to the prompt to a computing device for display via a user interface of the computing device. Additionally, or alternatively, broadcasting the prompt includes outputting the response to the prompt for display at the computing device via the user interface of the computing device.

Having described examples of procedures in accordance with one or more implementations, consider now an example of a system and device that can be utilized to implement the various techniques described herein.

### Example System and Device

FIG. 7 illustrates an example of a system generally at 700 that includes an example of a computing device 702 that is representative of one or more computing systems and/or devices that may implement the various techniques described herein. This is illustrated through inclusion of the application 108 and the learning model system 104. The computing device 702 may be, for example, a server of a service provider, a device associated with a client (e.g., a client device), an on-chip system, and/or any other suitable computing device or computing system.

The example computing device 702 as illustrated includes a processing system 704, one or more computer-readable media 706, and one or more I/O interfaces 708 that are communicatively coupled, one to another. Although not shown, the computing device 702 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 704 is representative of functionality to perform one or more operations using hardware. Accordingly, the processing system 704 is illustrated as including hardware elements 710 that may be configured as processors, functional blocks, and so forth. This may include implementation in hardware as an application specific integrated circuit or other logic device formed using one or more semiconductors. The hardware elements 710 are not limited by the materials from which they are formed, or the processing mechanisms employed therein. For example, processors may be comprised of semiconductor(s) and/or transistors (e.g., electronic integrated circuits (ICs)). In such a context, processor-executable instructions may be electronically executable instructions.

The computer-readable media 706 is illustrated as including memory/storage 712. The memory/storage 712 represents memory/storage capacity associated with one or more computer-readable media. The memory/storage 712 may include volatile media (such as random-access memory (RAM)) and/or nonvolatile media (such as read only memory (ROM), Flash memory, optical disks, magnetic disks, and so forth). The memory/storage 712 may include fixed media (e.g., RAM, ROM, a fixed hard drive, and so on) as well as removable media (e.g., Flash memory, a removable hard drive, an optical disc, and so forth). The computer-readable media 706 may be configured in a variety of other ways as further described below.

Input/output interface(s) 708 are representative of functionality to allow a user to enter commands and information to computing device 702, and also allow information to be presented to the user and/or other components or devices using various input/output devices. Examples of input devices include a keyboard, a cursor control device (e.g., a mouse), a microphone, a scanner, touch functionality (e.g., capacitive, or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 702 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 702. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable, and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 702, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 710 and computer-readable media 706 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 710. The computing device 702 may be configured to implement particular instructions and/or functions corresponding to the software and/or hardware modules. Accordingly, implementation of a module that is executable by the computing device 702 as software may be achieved at least partially in hardware, e.g., through use of computer-readable storage media and/or hardware elements 710 of the processing system 704. The instructions and/or functions may be executable/operable by one or more articles of manufacture (for example, one or more computing devices 702 and/or processing systems 704) to implement techniques, modules, and examples described herein.

The techniques described herein may be supported by various configurations of the computing device 702 and are not limited to the specific examples of the techniques described herein. This functionality may also be implemented all or in part through use of a distributed system, such as over a “cloud” 714 via a platform 716 as described below.

The cloud 714 includes and/or is representative of a platform 716 for resources 718. The platform 716 abstracts underlying functionality of hardware (e.g., servers) and software resources of the cloud 714. The resources 718 may include applications and/or data that can be utilized while computer processing is executed on servers that are remote from the computing device 702. Resources 718 can also include services provided over the Internet and/or through a subscriber network, such as a cellular or Wi-Fi network.

The platform 716 may abstract resources and functions to connect the computing device 702 with other computing devices. The platform 716 may also serve to abstract scaling of resources to provide a corresponding level of scale to encountered demand for the resources 718 that are implemented via the platform 716. Accordingly, in an interconnected device embodiment, implementation of functionality described herein may be distributed throughout the system 700. For example, the functionality may be implemented in part on the computing device 702 as well as via the platform 716 that abstracts the functionality of the cloud 714.

### CONCLUSION

Although the systems and techniques have been described in language specific to structural features and/or methodological acts, it is to be understood that the systems and techniques defined in the appended claims are not necessarily limited to the specific features or acts described. Rather, the specific features and acts are disclosed as example forms of implementing the claimed subject matter.

What is claimed is:

1. A computer-implemented method comprising:
receiving a prompt for performing a task using a learning model, wherein the task comprises a plurality of intermediate tasks;
generating a graph to represent a plurality of relationships between at least one term included in the prompt and a plurality of additional terms associated with performing the task, wherein the graph includes:
a plurality of nodes corresponding to the at least one term and the plurality of additional terms; and
a plurality of edges connecting the plurality of nodes, the plurality of edges corresponding to the plurality of relationships between the at least one term and the plurality of additional terms;
performing, based on the graph, the plurality of intermediate tasks to obtain a response to the prompt, the plurality of intermediate tasks associated with the plurality of additional terms;
removing one or more nodes of the plurality of nodes from the graph responsive to results of the plurality of intermediate tasks; and
broadcasting the response to the prompt.

2. The computer-implemented method of claim 1, wherein performing the plurality of intermediate tasks comprises:
traversing the plurality of nodes via the plurality of edges to obtain respective intermediate tasks of the plurality of intermediate tasks, wherein the respective intermediate tasks are related to performing the task;
performing, for respective additional terms of the plurality of additional terms, the respective intermediate tasks to obtain the results; and
updating the graph based on the results.

3. The computer-implemented method of claim 2, wherein updating the graph comprises one or more of storing information associated with the respective additional terms at respective nodes of the plurality of nodes or storing a context of the respective additional terms at the respective nodes, and wherein the respective nodes correspond to the respective additional terms.

4. The computer-implemented method of claim 1, wherein performing the plurality of intermediate tasks comprises one or more of:
obtaining information associated with the plurality of additional terms; or
determining a context of the plurality of additional terms based on the plurality of relationships between the at least one term and the plurality of additional terms.

5. The computer-implemented method of claim 1, wherein removing the one or more nodes is based on a size of the graph satisfying a threshold value.

6. The computer-implemented method of claim 1, further comprising:
receiving user input that indicates the at least one term and the plurality of additional terms, wherein the at least one term and the plurality of additional terms include natural language values; and
parsing the user input to obtain the plurality of relationships between the at least one term and the plurality of additional terms.

7. The computer-implemented method of claim 1, further comprising:
obtaining, based on accessing a database storing the plurality of additional terms and the at least one term, data indicating the at least one term and the plurality of additional terms; and
parsing the data to obtain the plurality of relationships between the at least one term and the plurality of additional terms.

8. The computer-implemented method of claim 1, wherein broadcasting the response to the prompt comprises transmitting, to a computing device, the response to the prompt for display via a user interface of the computing device.

9. The computer-implemented method of claim 1, wherein broadcasting the response to the prompt comprises outputting, for display at a computing device, the response to the prompt via a user interface of the computing device.

10. The computer-implemented method of claim 1, wherein the task includes one or more of a request for information corresponding to the at least one term, a request for context associated with the at least one term, or a request to define the at least one term.

11. A system comprising:
one or more processors; and
a computer-readable storage medium storing instructions that are executable by the one or more processors to perform operations comprising:
receiving a prompt for performing a task using a learning model, wherein the task comprises a plurality of intermediate tasks;
generating a graph to represent a plurality of relationships between at least one term included in the prompt and a plurality of additional terms associated with performing the task, wherein the graph includes:
a plurality of nodes corresponding to the at least one term and the plurality of additional terms; and
a plurality of edges connecting the plurality of nodes, the plurality of edges corresponding to the plurality of relationships between the at least one term and the plurality of additional terms;
performing, based on the graph, the plurality of intermediate tasks to obtain a response to the prompt, the plurality of intermediate tasks associated with the plurality of additional terms;
removing one or more nodes of the plurality of nodes from the graph responsive to results of the plurality of intermediate tasks; and
broadcasting the response to the prompt.

12. The system of claim 11, wherein to perform the plurality of intermediate tasks, the operations further comprise:
traversing the plurality of nodes via the plurality of edges to obtain respective intermediate tasks of the plurality of intermediate tasks, wherein the respective intermediate tasks are related to performing the task;
performing, for respective additional terms of the plurality of additional terms, the respective intermediate tasks to obtain the results; and
updating the graph based on the results.

13. The system of claim 11, wherein to perform the plurality of intermediate tasks, the operations further comprise one or more of:
obtaining information associated with the plurality of additional terms; or
determining a context of the plurality of additional terms based on the plurality of relationships between the at least one term and the plurality of additional terms.

14. The system of claim 11, wherein removing the one or more nodes is based on a size of the graph satisfying a threshold value.

15. A computer-implemented method comprising:
receiving a prompt for performing a task using a learning model, wherein the task comprises a plurality of intermediate tasks;
generating a graph to represent a plurality of relationships between at least one term included in the prompt and a plurality of additional terms associated with performing the task;
performing, based on the graph, the plurality of intermediate tasks to obtain a response to the prompt, the plurality of intermediate tasks associated with the plurality of additional terms; and
broadcasting the response to the prompt.

16. The computer-implemented method of claim 15, wherein performing the plurality of intermediate tasks comprises:
traversing the graph to obtain respective intermediate tasks of the plurality of intermediate tasks, wherein the respective intermediate tasks are related to performing the task;
performing, for respective additional terms of the plurality of additional terms, the respective intermediate tasks to obtain results of the plurality of intermediate tasks; and
updating the graph based on the results.

17. The computer-implemented method of claim 15, wherein performing the plurality of intermediate tasks comprises one or more of:
obtaining information associated with the plurality of additional terms; or
determining a context of the plurality of additional terms based on the plurality of relationships between the at least one term and the plurality of additional terms.

18. The computer-implemented method of claim 15, further comprising:
receiving user input that indicates the at least one term and the plurality of additional terms, wherein the at least one term and the plurality of additional terms include natural language values; and
parsing the user input to obtain the plurality of relationships between the at least one term and the plurality of additional terms.

19. The computer-implemented method of claim 15, further comprising:
obtaining, based on accessing a database storing the plurality of additional terms and the at least one term, data indicating the at least one term and the plurality of additional terms; and
parsing the data to obtain the plurality of relationships between the at least one term and the plurality of additional terms.

20. The computer-implemented method of claim 15, wherein broadcasting the response to the prompt comprises:
transmitting, to a computing device, the response to the prompt for display via a user interface of the computing device; or
outputting, for display at the computing device, the response to the prompt via the user interface of the computing device.
